(19) United States
(12) Patent Application Publication
(10) Pub. No.: US 2012/0072356 A1
(43) Pub. Date: Mar. 22, 2012

(54) DATA-PROCESSING SYSTEM AND METHOD

(76) Inventors: Delia Welty, Mamaroneck, NY (US); Charles A. Miraglia, Bronx, NY (US); Thomas J. Ledden, Mamaroneck, NY (US)

(21) Appl. No.: 13/239,785

(22) Filed: Sep. 22, 2011

Related U.S. Application Data
(60) Provisional application No. 61/385,262, filed on Sep. 22, 2010.

(51) Int. Cl. G06Q 10/00

(52) U.S. Cl. 705/305

(57) ABSTRACT

An elevator inspection system to provide real-time access to workflow processing information for the elevator inspection industry is described.

### FIELD OF THE INVENTION

The present invention relates to a data-processing system and method, in particular to an elevator inspection system that provides real-time access to workflow processing information related to elevator inspections.

### BACKGROUND

The Department of Buildings (DOB) in the City of New York requires all elevators to be inspected annually. The inspection of each elevator in each building is a time-consuming and complicated process having many different steps, paperwork and documentation requirements, and predetermined deadlines. In addition to New York City, every major city has a need for annual elevator inspections, each having its own governing agencies and unique codes and requirements.

In an example of an inspection of a single elevator, an inspection performing company and a third-party witnessing agency is hired by a building owner or property manager. The inspection is scheduled, performed, and completed, and the completed inspection report (ELV-3) is sent by the third-party witnessing agency to the inspection performing company for its Agency Director's signature. It is then signed by the third-party witnessing agency Director and he signs on the client's behalf, or if no authorization is given to the witnessing agency, the form is sent to the owner/property manager for their signature. The signed inspection report is returned to the witnessing agency, and the form is physically delivered to and filed with the Department of Buildings within a predetermined deadline from the time of inspection, e.g., 45 days. The Department of Buildings stamps the ELV-3 form and logs the date and results of the inspection into their database, known as Building Information System. The witnessing agency will receive in a few weeks or months the official stamped copy of the form, which may then be forwarded by the witnessing agency to the building owner/property manager for their records. The witnessing agency may be responsible for actively checking the Building Information System online to insure that the clients' inspections are all accounted for, thereby insuring that the client does not receive a monetary penalty for not completing and filing their annual inspection.

At each step of the inspection process, there are many potential sources of delay and complication. There may be delays during the inspection process in the field (e.g. buildings might be unexpectedly closed due to religious holidays; superintendents may not be available to allow entry by inspection teams; bad weather may cause street closings and prevent inspection teams from getting to the building; parades/police activity may prevent inspection teams from getting to the building; miscommunications in scheduling between the performing company and the witnessing agency may sometimes occur; teams or inspectors may arrive late to the building). There may also be delays in providing the completed inspection data to a processing department of an inspection company if the inspector cannot relay the test results in a timely manner. Delays may be caused by not completing the necessary paperwork immediately after a test is conducted. Certain documentation (e.g. Tax Exempt Certificates) may not be provided to the witnessing agency to file a test form. Payment of invoices to the witnessing agency may result in a delay in filing a completed form. Proper checks made out to the Department of Buildings for filing fees may not have been provided to the witnessing agency, causing further delays in filing a test form. Inspection performing companies may not sign and return to the witnessing agency the inspection report causing further delays. Building owners/property managers may cause delays by not signing and promptly returning the completed test form to the witnessing agency. All of these variables may cause a delay in filing a completed test form with the Department of Buildings within the mandated 45-day deadline. In addition, there are additional complications of errors in the inspection data, errors in the paperwork, lost papers, lost mail, and many other potential complications and delays. Regardless of whether a particular elevator inspection reported no deficient items or many such deficiencies, any and all of the above-discussed delays and errors may apply.

As a result, for each particular elevator inspection, a third-party witnessing agency or inspection company may receive numerous phone calls or inquiries from the building owner/property manager regarding the status of one or more of its elevator inspections as it moves through its lifecycle from scheduling to filing with the DOB. Examples of potential inquiries may include:
the scheduling of an inspection,
the progress of an inspection,
the estimated completion date of an inspection,
the estimated completion of the inspection form,
the mailing of the completed paperwork and documentation to the performing company for signature,
the mailing of the completed paperwork and documentation to the building owner/property manager for signature,
the particular details of a completed inspection, including the meaning of any deficiencies noted during the inspection,
the mailing of the signed paperwork to the third-party witnessing agency,
the delivery of the completed test report to the Department of Buildings, and
the filing status of the signed paperwork.

There are, for example, more than 70,000 vertical transportation devices (including passenger elevators, escalators, wheelchair lifts, dumbwaiters, sidewalk lifts, man-lifts and freight cars) in New York City alone that require annual inspections. Thus, for an inspection company or witnessing agency handling hundreds or even thousands of elevator inspections in a single year, the volume of customer calls and inquiries requires many person-hours of time and attention that cannot be directed to other back-office functions. Combine that with the sheer volume of paperwork, documentation, tracking and follow-up necessary for processing inspection reports for each elevator inspection, and back-office processing can very quickly become time-consuming, expensive and often unmanageable.

Further, due to the predetermined deadlines set, for example, by the New York City Department of Buildings for the completion of elevator inspections, a swift, seamless inspection process is extremely desirable and important to all parties involved. An inspection completed within the 45-day deadline will: minimize owner cost as penalties will not be imposed; minimize risk for the building owner as they will be code compliant and in possession of safe-running elevators; maximize passenger safety as deficient items are required to be repaired within 45 business days of the filing date of the test report; maximize profitability for performing and witnessing agencies as more tests can be scheduled and completed quickly; and maximize investment and time expenditures for all parties involved.

In case of delayed completion and/or other non-compliance with the rules and standards set by the Department of Buildings, penalties and/or fines may be imposed upon the building owner—some reaching upwards of $5,000 per elevator device. Delays also cost the performing company and witnessing agency time, money and a great deal of aggravation.

This particular set of safety codes/penalties for vertical transportation devices as discussed herein is unique to New York City—home to the United States' largest number of vertical transportation devices—and sets the standard nationwide for safety compliance. In fact, a full 10% of America's vertical transportation devices are located within the five boroughs of New York City. Similar but different procedures exist in most of the major metropolitan areas across the country.

Accordingly, there is a long-felt need in the elevator inspection industry to provide an inspection data-processing system having a method for real-time access to workflow processing information for each and every elevator inspection that will: streamline the process; reduce the number of person-hours devoted to phone calls and customer service inquiries; reduce delays and errors; reduce the amount of paperwork; provide useful and accurate information to customers through a global electronic network with an understandable computer interface; and meet all applicable deadlines

The present invention, described herein, provides these advantages and others that will be readily apparent to those of ordinary skill in the art.

### SUMMARY

In a non-limiting embodiment of the present invention, a system for data processing comprises at least one recording device configured to record data related to an elevator inspection task, a central computing device configured to receive the data from the at least one recording device and populate a database with the received data, a processing device configured to receive the data from the central computing device, translate the data into a format understandable within the framework of elevator inspection processing, and modify the data, and at least one portal configured to receive the data from the processing device and display workflow processing information based on the data related to the elevator inspection task. Alternatively and/or additionally, the data may be updated in the central computing device.

In another non-limiting embodiment of the present invention, a method of data processing comprises recording, using at least one recording device, data related to an elevator inspection task, populating a database of a central computing device with the data received from the at least one recording device, at a processing device: receiving the data from the central computing device, translating the data into a format understandable within the framework of elevator inspection, and modifying the data, and displaying, on at least one portal, workflow processing information based on the data related to the elevator inspection task. Alternatively and/or additionally, the method may include updating the data in the central computing device.

The present invention provides an inspection data-processing system having a method for real-time access to workflow processing information for the elevator inspection industry. Real-time may include both actual real-time and close to real-time, accounting for delays such as processing, transmission, reception, translation, and others. Although the present invention will be discussed herein with regard to the elevator inspection industry, it should be understood by those of ordinary skill in the art that the present invention may be applicable to other fields of use as well, and should not be limited to the examples described herein.

### BRIEF DESCRIPTION OF THE DRAWINGS

FIG. 1 is a schematic diagram of an inspection data-processing system according to an exemplary embodiment of the present invention.

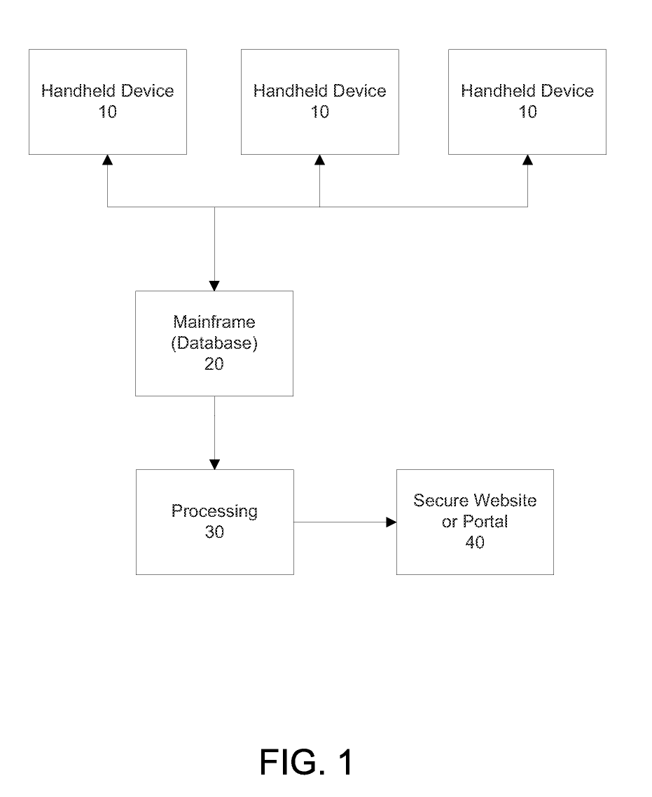

FIG. 2 is a schematic diagram of a data-processing method according to an exemplary embodiment of the present invention.

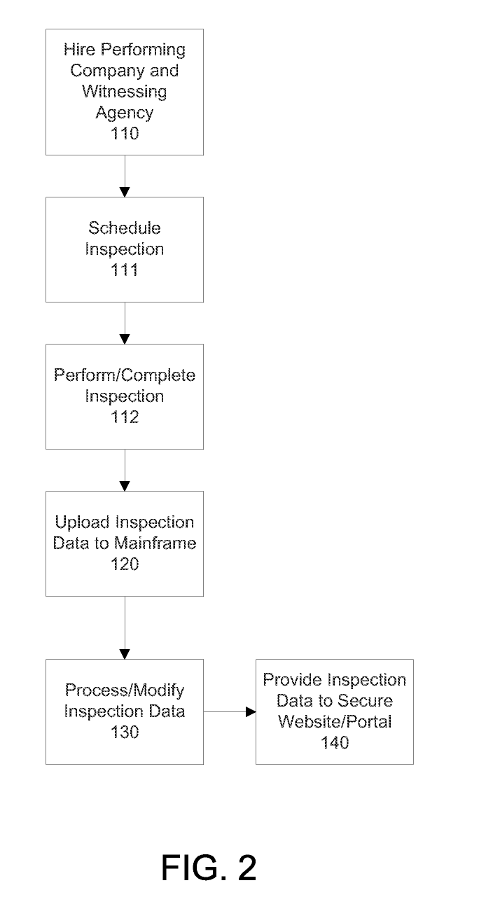

### DETAILED DESCRIPTION

Initially, an elevator inspection company that will perform the test and third-party witness who will witness the test are hired by a building owner or property manager to inspect one or more elevators in one or more buildings 110. The inspection of the elevators is scheduled between a performing company and a third- party witness 111, and a team performs the inspection with witnesses present at the scheduled date and time 112. The witness may make notes on the inspection on paper. However, preferably, and in the interest of saving time and collecting accurate data, the inspector may use a handheld device, such as a Motorola MC-75 (10), to take notes about the inspection, noting any deficient items in need of repair or replacement. For example, the handheld device 10 may use suitable software during the inspection, such as mobile software provided by MobileFrame LLC, 111 West Saint John Street, Suite 900, San Jose, Calif. 95113.

After the completion of the inspection, the witness may send or upload 120 the completed inspection notes to a mainframe 20, or other central computing device. If, on the other hand, the inspector made notes on paper, those notes may be faxed, or otherwise sent, to the office and inputted by hand into the mainframe 20, or other central computing device, by the Agency Director or another office employee.

The mainframe 20, or other central computing device, may act as a central repository for all data and information related to each and every elevator inspection, active and archived. The mainframe 20 may receive information 120 from a plurality of handheld devices 10 when the information is sent by the handheld devices 10, for example, at the completion of each inspection or periodically. Alternatively, the mainframe 20 may pull the information 120 from the handheld devices 10, for example, at the completion of each inspection or periodically.

When inspection data is uploaded 120 to the mainframe 20, the data is processed into a database containing all the elevator inspection data and information. The database may be filtered and/or sorted to extract particular desired data and information. In addition, the database may include scanned versions of particular documents, notes related to each inspection, and any other information related to each inspection.

A processing department 30, which may be a part of the inspection company, may then retrieve the data from the database. The processing department 30 may review the inspection data, generate forms and/or reports based on the data, provide the documents to various parties for signatures, update the status, notes, and/or data based on the current status of each inspection, and deliver and file the paperwork and documentation with the Department of Buildings. Any modifications, changes, additions, and/or deletions to the data may be processed 130 by the processing department 30. Alternatively and/or additionally, the data may be updated in the database in the mainframe 20. Further, additional documents may be scanned and uploaded using commercially available software, such as Kofax Capture™ provided by Optiform, Inc., for example. The data may be used by inspection agency personnel to inform clients as to the exact status of their tests/paperwork as they move through their lifecycle from scheduling to filing with the Department of Buildings.

For each particular elevator inspection, the mainframe 20 and/or the processing department 30 may include data including, but not limited to, identification of the building and elevator, type of inspection requested, scheduled inspection date and time, inspection progress, actual completion of inspection, paperwork and documentation status, delivery/filing status with the Department of Buildings, notes and/or deficiencies of the inspection, and any documents or forms associated with each step of the process.

In addition, the data for each elevator inspection may include a compliance indicator, or compliance clock, that indicates whether documents were timely filed with the DOB, the date of their filing, and/or the number of days remaining until the deadline for filing. For example, if the DOB requires documents to be filed within 45 days of the inspection, a color coded compliance clock may indicate green if the documents were timely filed, yellow if 15 days remain until the deadline for filing, and red if the deadline has passed without filing (as well as the number of days overdue). Alternatively, the compliance clock may use codes other than color coding to indicate compliance status to a customer in a user-friendly manner.

Further, the data for each elevator inspection may include a confirmation field that indicates whether the inspection data has been entered into the computerized Building Information System (BIS) of the DOB, as this confirmation may occur some time after delivery/filing of documents with the DOB. This confirmation field may provide positive or negative confirmation via color coding, simple words or phrases such as “Yes” or “No”, “Y” or “N”, check marks or “X” marks, or other codes that indicate confirmation status to a customer in a user-friendly manner.

Moreover, the data for each elevator inspection may include an Affirmation of Corrections (AOC) due date field. The AOC field may provide the customer with a due date tracking function in order to manage the timely correction of any deficiencies noted in the inspection. For example, if the DOB requires correction of noted deficiencies within 45 business days, the AOC field may provide a countdown or other due date tracking information. This AOC field may provide a due date, color coding indicating the status, completion date, or time remaining for corrections, or other types of codes in order to indicate the status of corrections and/or the time remaining to correct any noted deficiencies to a customer in a user-friendly manner.

Further, the processing department 30 may manage the provision 140 of data to a secure website or portal 40. Each building owner or property manager (customer) may be provided access to a website or portal 40 through which each customer may view the status, history, and key documents, relating to their scheduled, pending, in-progress, and completed inspections via the inspection agency's website. Each customer may be provided with a username and password to access the inspection agency's secure website 40, or any other known method may be used to ensure that each customer is able to view only its own secure data.

The secure website 40 may retrieve data 140 from the processing department 30 to populate information fields of each customer's inspections, for example, either periodically or when a customer logs in, or the processing department 30 may push data 140 from the database to the secure website 40, for example, either periodically or when a customer logs in.

Once logged into the secure website 40, a customer may view its inspections by building and/or by elevator device. The secure website 40 may include identification of each building and each elevator, and a progress bar, graph, and/or timeline, etc. that shows the current status of each inspection. In addition, the secure website 40 may include links to uploaded documents relevant to particular stages of the inspection process.

A clear advantage to providing a customer with their data via the secure website 40 is that they can see the status of their tests in real-time, and may more easily identify a delay in the filing of their inspection reports, thereby avoiding costly monetary penalties.

Further, the customer may also view which inspections are still in need of scheduling. The customer may or may not be aware of which tests are scheduled for the year, and seeing an accurate list online may help the customer to stay code compliant by reminding the customer to schedule outstanding tests.

The secure website 40 may automatically email alerts to customers at certain stages of the inspection progress. In addition, the secure website 40 may also email alerts to administrative personnel, for example, if there are too many incorrect login attempts.

Further, the secure website 40 may include test results and/or other notes that provide additional information to customers in a user-friendly and easily understandable format. In this regard, different stages of the inspection process, documentation, and test results may typically be referred to by standardized codes that are known most readily to those in the elevator inspection industry. However, such codes may not be understandable to building owners or property managers. Accordingly, the information provided on the secure website may provide translated or transcribed data, so that inspection information may be more easily understandable to a customer. The advantage to the secure website user/inspection customer is they may more easily identify what is wrong with their elevator devices and can more easily converse with their elevator maintenance companies about the quickest, most cost-effective course of repairs. They also can, by way of the number of deficient items, identify how the maintenance company is performing within the terms of their maintenance contracts, as it is the witnessing agency that reports all deficient items on the completed test report. When deficient items are no longer listed in a complicated code, owners and property managers are more in control of their elevator device repair and maintenance issues.

Each step of the data-processing system and method described in the present application may serve to streamline the elevator inspection process, eliminate errors, delays, and other complications, provide real-time, useful workflow processing information to customers, decrease the volume of inquiries directed to inspection companies, reduce costs associated with the inspection process, and facilitate the meeting of all applicable deadlines.

By using handheld devices 10 during elevator inspections, an inspector may complete inspections more quickly, the inspection data may be quickly organized and transferred to a database in a mainframe 20, delays may be minimized, errors of manually entering inspection data to the database may be reduced, and the loss of data may be eliminated.

By storing all the inspection data and information in a database in a mainframe 20, or other central computing device, accuracy of data may be ensured, duplication of data may be eliminated, processing of data may be streamlined, and availability of data may be improved. Any changes to the data and information may be processed by a processing department 30 and provided on the secure portal 40 to customers, such that confusion and delays with respect to the progress of elevator inspections may be avoided.

By providing the inspection data to a secure website or portal 40 for each customer, accurate and timely inspection data may be provided to each customer, the volume of customer inquiries to the inspection agency may be greatly reduced, communication with customers may be vastly improved, customers may be more aware and in control of their inspections, making their lives/jobs easier, potential delays and associated penalties and/or fines may be eliminated, and transparency of the process and satisfaction of customers may be improved.

What is claimed is:

1. A system for data processing, comprising:
at least one recording device configured to record data related to an elevator inspection task;
a central computing device configured to receive the data from the at least one recording device and populate a database with the received data;
a processing device configured to receive the data from the central computing device, translate the data into a format understandable within the framework of elevator inspection processing, and modify the data; and
at least one portal configured to receive the data from the processing device and display workflow processing information based on the data related to the elevator inspection task.

2. The system of claim 1, wherein the at least one recording device is a portable handheld device.

3. The system of claim 1, wherein at least one of (a) the at least one recording device pushes the data to the central computing device, and (b) the central computing device pulls the data from the at least one recording device, one of (a) on demand and (b) periodically.

4. The system of claim 1, wherein the processing device translates codes in the data into a format easily understandable by a customer.

5. The system of claim 1, wherein the processed data includes at least one of inspection data, inspection schedules, inspection status, inspection forms, compliance data, confirmation data, and corrections data.

6. The system of claim 1, wherein at least one of (a) the processing device pushes the processed data to the at least one portal, and (b) the at least one portal pulls the processed data from the processing device, one of (a) on demand and (b) periodically.

7. The system of claim 1, wherein the at least one portal displays workflow processing information of a customer in a secure, user-friendly and easily understandable format.

8. The system of claim 1, wherein the at least one portal sends alerts to a customer based on the workflow processing information.

9. A method of data processing, comprising:
recording, using at least one recording device, data related to an elevator inspection task;
populating a database of a central computing device with the data received from the at least one recording device;
at a processing device:
receiving the data from the central computing device,
translating the data into a format understandable within the framework
of elevator inspection, and
modifying the data; and
displaying, on at least one portal, workflow processing information based on the data related to the elevator inspection task.
